(19) United States
(12) Patent Application Publication
(10) Pub. No.: US 2018/0130026 A1
(43) Pub. Date: May 10, 2018

(54) PER-ITEM UPDATES TO CALENDAR ITEMS ASSOCIATED WITH LIVE EVENTS

(71) Applicant: Microsoft Technology Licensing, LLC, Redmond, WA (US)

(72) Inventors: Chandresh Kumar Jain, Sammamish, WA (US); Lavanya Vasudevan, Sammamish, WA (US); Ryan Becker, Redmond, WA (US); Ying Zhang, Issaquah, WA (US)

(21) Appl. No.: 15/344,942

(22) Filed: Nov. 7, 2016

(51) Int. Cl. G06Q 10/10

(52) U.S. Cl. CPC G06Q 10/1095

(57) ABSTRACT

Systems, methods, and software technology for updating calendar items associated with live events on a per-item basis. A calendar client application communicates an update request to a calendar service for an update to a calendar item in a calendar associated with a user that is related to a live event. The calendar service queries a search service for status information on the event and replies to the client with the status information. The client receives the reply and may responsively surface the status information a user interface to the calendar.

### TECHNICAL BACKGROUND

Among the features and functionality provided by many calendar applications and their associated services, team calendars, religious calendars, and other interesting calendars may now be subscribed to by an end-user. Once subscribed to a calendar of interest, the events of that calendar are automatically added to and maintained in the end-user's own calendar. Such an arrangement allows the end-user to quickly and easily see when their favorite team plays or when important holidays are upcoming.

In fact, some calendars of interest may be updated as a given event proceeds live or at its conclusion. For example, a calendar item in a user's calendar associated with a professional baseball game may be updated during the game to show the score in-progress, or after the game to show the final score, eliminating the need for the user to consult another information source.

However, such updates necessitate that the end-user be subscribed to the source calendar maintained by the team or other such organization associated with the live events in the calendar. This may be problematic if the source calendar falls behind or is otherwise sub-optimally maintained.

From a more technical perspective, the source calendar from which live updates are drawn may be inaccessible at times, preventing the user's calendar from being updated in a timely manner In addition, high subscription volumes may create a traffic burden on the systems, networks, and services the support the source calendar and the distribution of updates to the end-user calendars subscribed to the source.

### Overview

Technology is disclosed herein that allows calendar items associate with live events to be updated on a per-item basis in a user interface to a calendar.

In an implementation, a calendar client communicates an update request to a calendar service for an update to a calendar item in a calendar associated with a user that is related to a live event. The calendar service queries a search service for status information on the event and replies to the client with the status information. The client receives the reply and may responsively surface the status information in a user interface to the calendar. In this manner, end-users may enjoy the ease of use and convenience of live updates to ongoing events in their calendars, but without having to subscribe to an external calendar or calendars.

This Overview is provided to introduce a selection of concepts in a simplified form that are further described below in the Technical Disclosure. It may be understood that this Overview is not intended to identify key features or essential features of the claimed subject matter, nor is it intended to be used to limit the scope of the claimed subject matter.

### BRIEF DESCRIPTION OF THE DRAWINGS

Many aspects of the disclosure can be better understood with reference to the following drawings. While several implementations are described in connection with these drawings, the disclosure is not limited to the implementations disclosed herein. On the contrary, the intent is to cover all alternatives, modifications, and equivalents.

FIG. 1 illustrates an operational environment for employing enhanced calendar updating in an implementation.

FIG. 2 illustrates an update process employed by a calendar client in an implementation.

FIG. 3 illustrates an update process employed by a calendar service in an implementation.

FIG. 4 illustrates an operational scenario in an implementation related to the operational environment of FIG. 1.

FIG. 5 illustrates an operational sequence in an implementation related to the operational environment of FIG. 1.

FIG. 6 illustrates another operational scenario an implementation.

FIG. 7 illustrates another operational scenario an implementation.

FIG. 8 illustrates a computing system suitable for implementing the enhanced calendar update technology disclosed herein, including any of the environments, architectures, elements, processes, and operational scenarios and sequences illustrated in the Figures and discussed below in the Technical Disclosure.

### TECHNICAL DISCLOSURE

Software calendar technology is disclosed herein that allows an end-user to create calendar items in a calendar that may be updated on a per-item basis with status information pertaining to a live event. The technology includes a calendar client that monitors for when a user interacts with a calendar item that is associated with a live event. As an example, a user may open a calendar item, hover over an item, or navigate to a view in a calendar that includes at least one item associated with a live event.

When such an interaction occurs, the calendar client queries a calendar service for status information on the event. The calendar service responsively queries a search service for the status information and, once obtained, replies to the client with the status information. The calendar client may then surface all or some of the status information in a user interface to the calendar.

In some scenarios, the status information is surfaced as a card that is an overlay with respect to an underlying view in the user interface. In other examples, an opened item is populated with the status information or an item displayed within a grid is updated to display the status information. The status information may also be displayed in a message bubble when a user hovers over an event. Many other techniques are possible for surfacing the status information and may be considered within the scope of the present disclosure.

The status information may be, for example, dynamic details of the live event that may change as the live event proceeds, such as a score, a stock price, a flight's progress, or the like. However, the status information may be preview details about a live event before it occurs, which may also be dynamic Examples include start times for games, game lineups, concert lineups, ticket prices, or any other dynamic details. The status information may also be recap details that describe a live event that occurred in the past, such as a final score, attendance figures, published reviews, or the like. In other words, the status information may relate to dynamic details of a live event as it is ongoing, before the live event occurs, or after the live has occurred.

The status information may be in the form of alpha-numeric text strings that describe the details of the event, although other types of status information are possible, such as images, icons, and audio and/or video clips. In fact, a wide variety of information could be included in an update in some implementations to further enhance the usefulness of a calendar event. For instance, the status information could include dynamic links to websites, videos, images, or other such content related to an event. An event card could include, for example, a link to an e-commerce website containing merchandise, tickets, critics reviews, or other content pertaining to a live event.

Various technical effects may be appreciated from the foregoing description and examples. For example, the person using the calendar client may discover the live score of a game, the current value of a stock price, or other such information that may change in real-time, without having to consult another source. The increased usability (and reduction in manual steps) may lead to increased enjoyment of an application and service.

In some implementations, a given calendar item may have been created manually by the user, as opposed to being scheduled as part of a calendar subscription. Thus, the calendar item may be updated with status information from its referenced event, without the item having originated from a subscription. Such an ability obviates or at least mitigates the need for users to subscribe to external calendars for updates on live events. Rather, a user can simply create an event in that person's calendar which refers to a live event. The client, in coordination with the service, can update the item with status information on the live information, regardless of the existence of any other calendar(s) maintained other entities.

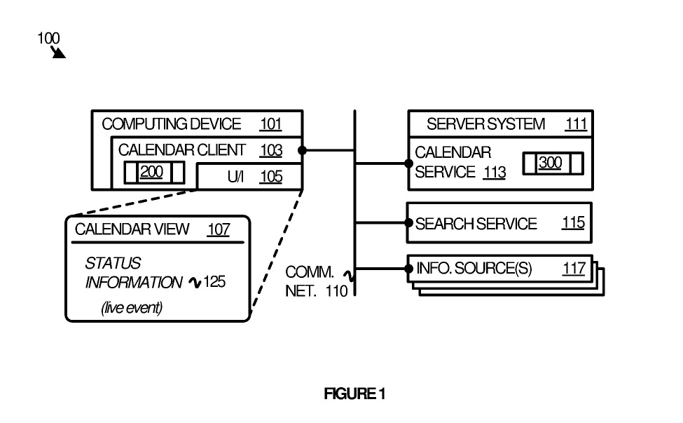

FIG. 1 illustrates an operational environment 100 in an implementation to highlight various aspects of the enhanced calendar updating technology disclosed herein. Operational environment 100 includes computing device 101 and server system 111. Calendar client 103 runs on computing device 101 and interacts with calendar service 113, which runs on server system 111. Operational environment 100 also includes a search service 115 and one or more information sources, represented by information source 117. Communication network 110 is representative one or more communication networks that may connect calendar client 103, calendar service 113, search service 115, and information source 117 and their respective computing environments.

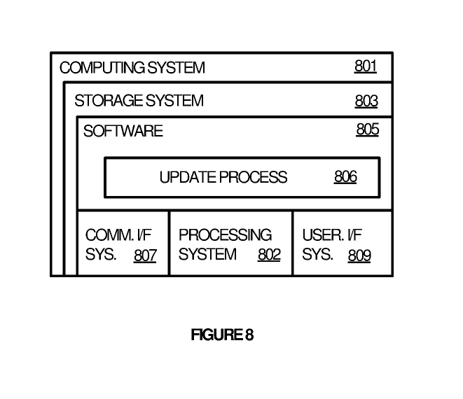

Computing device 101 is representative of any device or devices on which an application or applications may run (e.g. calendar client 103), of which computing system 801 in FIG. 8 is representative. Examples include, but are not limited to, laptop and desktop computers, mobile phones, tablet computers, computers of hybrid form-factors, wearable computing devices, personal computing appliances, and any other suitable physical or virtual computing device, as well as any combination or variation thereof.

Server system 111 is representative of any server or servers on which an application service may run (e.g. calendar service 113), of which computing system 801 is also representative. Examples include, but are not limited to, server computers, web servers, application servers, blade servers, virtual machines, containers, and any other suitable computing system, whether physical, virtual, logical, or any combination thereof. Server system 111 may be deployed in a large-scale computing environment, such as a data center, in which many server systems run in a coordinated manner to provide a variety of services.

Calendar client 103 is representative of any application or application module capable of interfacing with a calendar service. Calendar client 103 may be deployed as a natively installed and executed application, a web-based application that runs in the context of a browser application, a stand-alone application or an integrated module or component of a larger application or suite, a desktop application, a mobile application, or any other type of application, variation, or combination thereof. Examples include, but are not limited to, Outlook® and Outlook Web App (OWA), as well as Gmail®.

Calendar client 103 includes a user interface 105 with which a user may interact to experience the features and functionality of the client and service. In one brief example, a calendar view 107 and status information 125 for a live event may be rendered in user interface 105, as will be discussed in more detail below.

Calendar service 113 is representative of any online service capable of interfacing with calendar clients, examples of which include Microsoft Exchange®. Calendar service 113 may be deployed as a stand-alone service or in the context of a suite of online service and may sometimes be referred to colloquially as a “cloud computing” service.

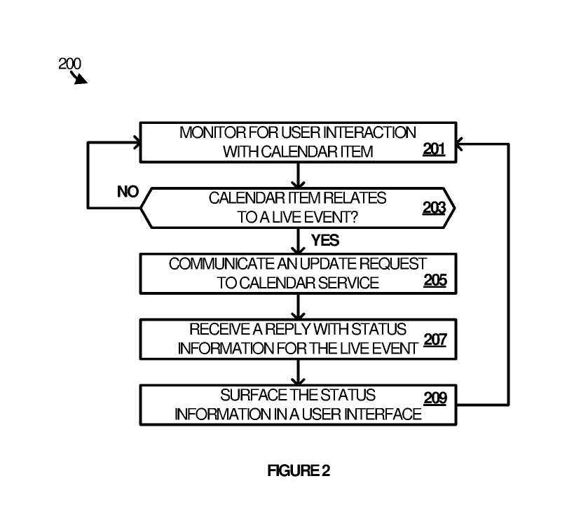

Update process 200 in FIG. 2 is representative of a process that may be employed by calendar client 103 to update calendar items with respect to live events. Update process 200 may be embodied in one or more components or modules of calendar client 103 as program instructions that are executed by computing device 101. The following discussion makes parenthetical reference to the steps illustrated in FIG. 2.

In operation, a given calendar client employing update process 200 monitors for user interaction with a calendar item in a view (step 201). The interaction may involve a user interacting specifically with an item in a user interface to the client, such as by providing user input to open an item. However, the interaction may more broadly be user input to navigate to a view that includes a new item or items relative to a previous view supplied in a user interface to the calendar client.

When such an interaction is detected, the calendar client determines if the item or items relate to a live event (step 203). This may be indicated by a flag set in association with an item, meta data stored in association with and item, or by some other indicator. If an item relates to a live event, the calendar client communicates an update request to a calendar service (step 205). The update request may identify the (live) event that is the subject of the calendar item, such that the calendar service can obtain status information on the event.

The calendar service replies to the update request with the status information, which is received by the calendar client (step 207). The calendar client may then surface the status information in the user interface to the client (step 209).

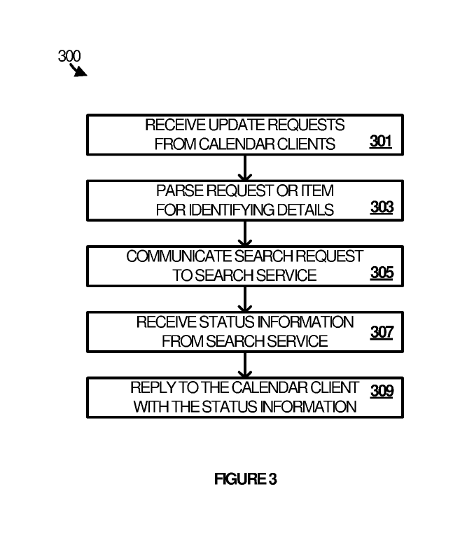

Update process 300 in FIG. 3 is representative of a process that may be employed by calendar service 113 to assist with updating calendar items associated with live events. Update process 300 may be embodied in one or more components or modules of calendar service 113 as program instructions that are executed by server system 111. The following discussion make parenthetical reference to the steps illustrated in FIG. 3.

In operation, a given calendar service employing update process 113 receives update requests for calendar clients making requests for calendar items to be updated (step 301). When such a request is received, the calendar service parses the request or the associated calendar item itself for event-identifying details (step 303). The request or item may identity an event by a name, for example, that can be used to the calendar service to query a search service for status information.

Having found identifying information, the calendar service responsively communicates a search request to a search service in relation to the event represented by the calendar item (step 305). For instance, a calendar item that is the subject of an update request may reference a sporting event. The calendar service may thus submit a search request or query to a search service to search for details on the sporting event.

The search service may return details on the event, including details that may change as the event proceeds, such as the score of a game, the time remaining in a performance event, the time or distance remaining in a flight, or other such information that provides the live status of a scheduled event. The calendar service receives the status information (step 307) and responsively replies to the original update request with the status information (step 309). The calendar client can surface all or a portion of the status information in its user interface, possibly in the context of the calendar item or separately from the item. In some cases, the status information is returned in the form of a “card” that may be surfaced by the calendar client in its user interface.

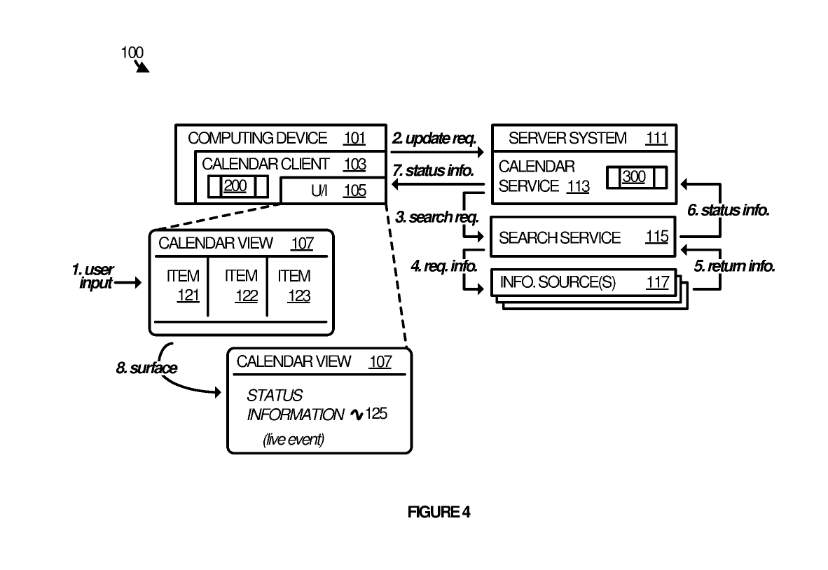

FIG. 4 illustrates an operational scenario with respect to the operational environment 100 of FIG. 1. To begin, an end-user supplies user input to computing device 101, which is directed to an element of calendar view 107 in user interface 105. The user may, for example, select an item to open in calendar view 107 from item 121, item 122, and item 123. In another example, the user may provide a user input to navigate from one view to another, e.g. from one month to another, one week to another, and so on.

When the user input relates to a calendar item for a live event, calendar client 103 responsively communicates an update request to calendar service 113 to have the calendar item updated with status information, if possible. Opening a calendar event for a live item or navigating to a view that includes a calendar item for a live event are examples of such user input. The update request may identify the live event as specified in the calendar item. In some situations, calendar client 103 may parse the calendar item for identifying information on the event and populate the update request with the identifying information, such as the name of the event. In other examples, identifying the calendar item itself may suffice, as calendar service 113 can retrieve identifying information itself.

Calendar service 113 receives the update request and responsively generates a search request to send to the search service 115. The search request may include identifying information on the event, such as its name or other keywords. Calendar service 113 may use any identifying information supplied in the update request or may supply the event-identifying information itself. In one example, the search request is composed in accordance with an application programming interface (API) for the Bing® knowledge and action graph. The calendar service 113 then communicates the search request to search service 115.

Search service 115 receives the search request and searches information source 117 for status information on the identified event. Information source 117 may be a graph maintained by search service 115. In other examples, information source 117 may represent a third-party source of information, such as a statistics service, a news service, one or more websites, or any other suitable source of information on live events. In some implementations, search service 115 may maintain a graph, index, list, or other data structures in a continuous manner explicitly querying information source 117 in response to a search request is unnecessary. In other implementations, search service 115 may explicitly request information from information source 117 in response to a search request.

Ultimately, status information on the live event is supplied to search service 115 from information source 117, which search service 115 uses to populate a reply to calendar service 113. Calendar service 113 takes the status information in the reply and communicates it to calendar client 103. In some implementations, calendar service 113 provides the status information in a “card” format, which is a user interface element that calendar client 103 can surface in user interface 105. Thus, calendar client 103 receives the status information and renders a representation of the status information in calendar view 107. Examples of calendar view 107 include an opened item, as well as a monthly, weekly, or daily view of an end-user's calendar.

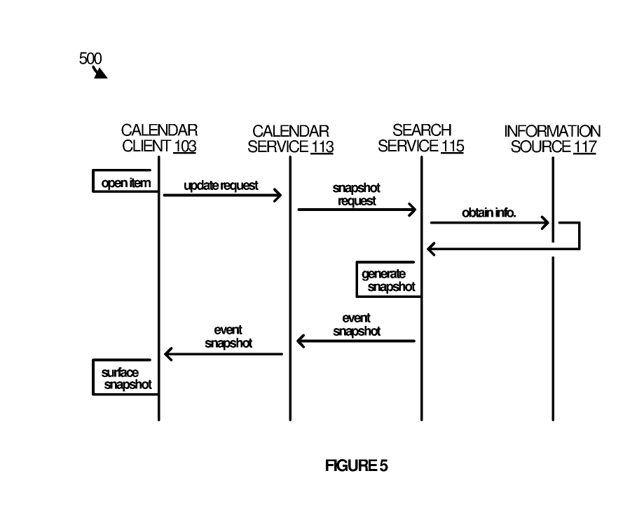

FIG. 5 illustrates an operational sequence 500 in an implementation to better highlight some aspects of the enhanced calendar technology disclosed herein. In operation, a user opens a calendar item in calendar client 103 that is related to a live event. Calendar client 103 responsively communicates an update request to calendar service 113 that identifies the live event. Calendar service 113 generates and sends a snapshot request to search service 115 to obtain status information on the live event, such as a live score, the progress of a flight, or other such information.

Search service 115 obtains the information from information source 117 and generates a snapshot of the event using the retrieved information. The snapshot is provided to calendar service 113, which forwards it with or without modification to calendar client 103. Calendar client 103 may then surface the snapshot in its user interface. As mentioned, the snapshot may be in the form of a “card” that may be displayed in the user interface.

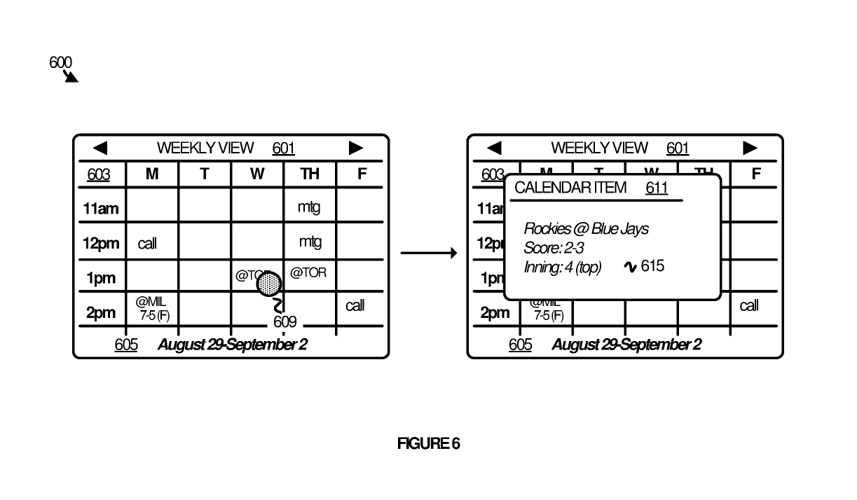

FIG. 6 illustrates an operational scenario 600 pertaining to an example of the user experience provided by the enhanced calendar technology disclosed herein. Operational scenario 600 begins with a weekly view 601 of a user's calendar. The weekly view 601 includes a calendar grid 603 defined by days of the week (Monday through Friday) and timeslots throughout each day. An information footer 605 identifies the date range initially represented in weekly view 601 (August 29^{th}-September 2^{nd}). Various events are scheduled throughout the week, such as phone calls, meetings, and live events.

For example, various calendar items associated with professional baseball games have been created in the calendar, including a ballgame at Milwaukee on Monday at 2:00 pm and two more at Toronto on Wednesday and Thursday respectively, both at 1:00 pm. The game at Milwaukee occurred in the past and has been updated with its final score. It is assumed for exemplary purposes that the first game against Toronto is in-progress, while the second game has yet to be played.

When user input 609 is supplied that opens the calendar item for the first game against Toronto, the calendar client application that renders weekly view 601 communicates an update request to its corresponding calendar service to obtain status information on the game. The calendar service queries a search service, which returns status information, and the calendar service replies to the client with the status information. The calendar client may then open the calendar item and populate it with some or all of the status information 615 returned by the calendar service. For example, calendar item 611 when opened shows the name of the teams competing in the game (Rockies and Blue Jays), the score (2-3) and the inning (top of 4^{th}).

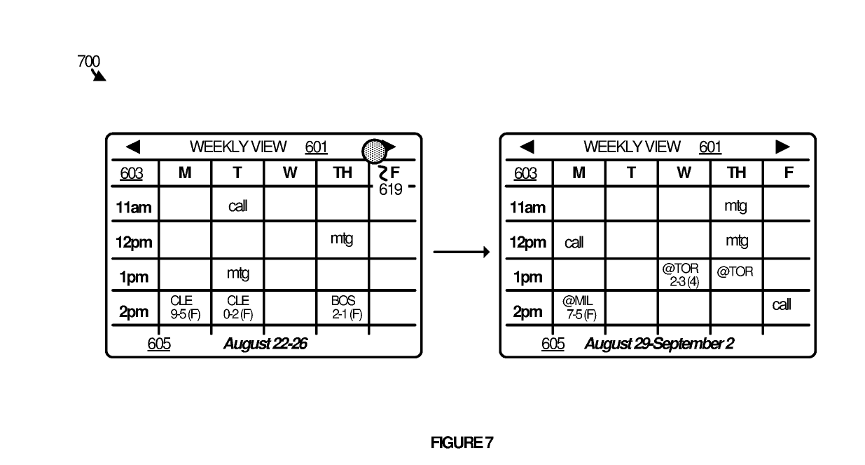

FIG. 7 illustrates operational scenario 700 pertaining to a slightly different example of the user experience provided by the enhanced calendar technology disclosed herein. Operational scenario 700 also begins with a weekly view 601 of a user's calendar. The weekly view 601 includes a calendar grid 603 defined by days of the week (Monday through Friday) and timeslots throughout each day. An information footer 605 initially identifies the date range initially represented in weekly view 601 (August 22^{th}-August 26^{th}). Various events are scheduled throughout the week, such as phone calls, meetings, and live events, including three past ballgames with their final scores indicated therein.

The end-user may desire to navigate to a different week, for instance from the past week to the present week. User input 619 is supplied to select a navigation button in weekly view 601 to move the view to the next week. The calendar client application that renders weekly view 601 communicates an update request to its corresponding calendar service to obtain status information on any live event that may be scheduled in the upcoming week to which the end-user navigated.

In some implementations, the calendar client examines each event in the next view for any that might be ongoing at the present time. The calendar client may then send an update request for each of the subset of calendar items that are associated with live events ongoing at the present time. In this example, the ballgame against Toronto is the only live event at the time of the user input 619. Accordingly, the calendar client send just one update request to the calendar service to obtain status information on the game.

The calendar service queries a search service, which returns status information, and the calendar service replies to the client with the status information. The calendar client may then open the calendar item and populate it with some or all of the status information returned by the calendar service. In this scenario, the calendar item in the weekly view is updated to show the score (2-3) and progress (4^{th} inning) of the game, as opposed to the scenario in FIG. 6 in which the calendar item is opened.

FIG. 8 illustrates computing system 801, which is representative of any system or collection of systems in which the various services, scenarios, and processes disclosed herein may be implemented. Examples of computing system 801 include, but are not limited to, server computers, rack servers, web servers, cloud computing platforms, and data center equipment, as well as any other type of physical or virtual server machine, container, and any variation or combination thereof. Other examples may include smart phones, laptop computers, tablet computers, desktop computers, hybrid computers, gaming machines, virtual reality devices, smart televisions, smart watches and other wearable devices, as well as any variation or combination thereof.

Computing system 801 may be implemented as a single apparatus, system, or device or may be implemented in a distributed manner as multiple apparatuses, systems, or devices. Computing system 801 includes, but is not limited to, processing system 802, storage system 803, software 805, communication interface system 807, and user interface system 809. Processing system 802 is operatively coupled with storage system 803, communication interface system 807, and user interface system 809.

Processing system 802 loads and executes software 805 from storage system 803. Software 805 includes update process 806, which is representative of the processes discussed with respect to the preceding FIGS. 1-7, including update process 200 and update process 300. When executed by processing system 802 to provide enhanced updating for calendar items, software 805 directs processing system 802 to operate as described herein for at least the various processes, operational scenarios, and sequences discussed in the foregoing implementations. Computing system 801 may optionally include additional devices, features, or functionality not discussed for purposes of brevity.

Referring still to FIG. 8, processing system 802 may comprise a micro-processor and other circuitry that retrieves and executes software 805 from storage system 803. Processing system 802 may be implemented within a single processing device, but may also be distributed across multiple processing devices or sub-systems that cooperate in executing program instructions. Examples of processing system 802 include general-purpose central processing units, application specific processors, and logic devices, as well as any other type of processing device, combinations, or variations thereof.

Storage system 803 may comprise any computer readable storage media readable by processing system 802 and capable of storing software 805. Storage system 803 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 803 may also include computer readable communication media over which at least some of software 805 may be communicated internally or externally. Storage system 803 may be implemented as a single storage device, but may also be implemented across multiple storage devices or sub-systems co-located or distributed relative to each other. Storage system 803 may comprise additional elements, such as a controller, capable of communicating with processing system 802 or possibly other systems.

Software 805 may be implemented in program instructions and among other functions may, when executed by processing system 802, direct processing system 802 to operate as described with respect to the various operational scenarios, sequences, and processes illustrated herein. For example, software 805 may include program instructions for implementing an update process for updating calendar items associated with live events.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 805 may include additional processes, programs, or components, such as operating system software, virtual machine software, or other application software, in addition to or that include update process 806. Software 805 may also comprise firmware or some other form of machine-readable processing instructions executable by processing system 802.

In general, software 805 may, when loaded into processing system 802 and executed, transform a suitable apparatus, system, or device (of which computing system 801 is representative) overall from a general-purpose computing system into a special-purpose computing system customized to provide enhanced calendar updating for live events. Indeed, encoding software 805 on storage system 803 may transform the physical structure of storage system 803. The specific transformation of the physical structure may depend on various factors in different implementations of this description. Examples of such factors may include, but are not limited to, the technology used to implement the storage media of storage system 803 and whether the computer-storage media are characterized as primary or secondary storage, as well as other factors.

For example, if the computer readable storage media are implemented as semiconductor-based memory, software 805 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 807 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

User interface system 809 is optional and may include a keyboard, a mouse, a voice input device, a touch input device for receiving a touch gesture from a user, a motion input device for detecting non-touch gestures and other motions by a user, and other comparable input devices and associated processing elements capable of receiving user input from a user. Output devices such as a display, speakers, haptic devices, and other types of output devices may also be included in user interface system 809. In some cases, the input and output devices may be combined in a single device, such as a display capable of displaying images and receiving touch gestures. The aforementioned user input and output devices are well known in the art and need not be discussed at length here.

User interface system 809 may also include associated user interface software executable by processing system 802 in support of the various user input and output devices discussed above. Separately or in conjunction with each other and other hardware and software elements, the user interface software and user interface devices may support a graphical user interface, a natural user interface, or any other type of user interface.

Communication between computing system 801 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses, computing backplanes, or any other type of network, combination of network, or variation thereof. The aforementioned communication networks and protocols are well known and need not be discussed at length here. However, some communication protocols that may be used include, but are not limited to, the Internet protocol (IP, IPv4, IPv6, etc.), the transfer control protocol (TCP), and the user datagram protocol (UDP), as well as any other suitable communication protocol, variation, or combination thereof.

In any of the aforementioned examples in which data, content, or any other type of information is exchanged, the exchange of information may occur in accordance with any of a variety of protocols, including FTP (file transfer protocol), HTTP (hypertext transfer protocol), REST (representational state transfer), WebSocket, DOM (Document Object Model), HTML (hypertext markup language), CSS (cascading style sheets), HTML5, XML (extensible markup language), JavaScript, JSON (JavaScript Object Notation), and AJAX (Asynchronous JavaScript and XML), as well as any other suitable protocol, variation, or combination thereof.

Certain inventive aspects may be appreciated from the foregoing disclosure, of which the following are various examples.

### EXAMPLE 1

A computing apparatus comprising: one or more computer readable storage media; a processing system operatively coupled with the one or more computer readable storage media; and program instructions stored on the one or more computer readable storage media for operating a calendar service that, when executed by a processing system, direct the processing system to at least: receive an update request originating from a calendar client for an update to a calendar item in a calendar associated with a user that is related to a live event; communicate a search request to a search service external to the calendar service to search for status information pertaining to the live event; and reply to the update request from the calendar client with the update comprising the status information obtained from the search service.

### EXAMPLE 2

The computing apparatus of Example 1 wherein the program instructions direct the processing system to communicate the search request to the search service in response to the update request for the update to the calendar item.

### EXAMPLE 3

The computing apparatus of Examples 1-2 wherein the program instructions direct the processing system to determine if update requests originating from calendar clients for updates to calendar items qualify for live updating.

### EXAMPLES 4

The computing apparatus of Examples 1-3 wherein the program instructions direct the processing system to communicate the search request to the search service in response to determining that the calendar item qualifies for the live updating.

### EXAMPLE 5

The computing apparatus of Examples 1-4 wherein the update request to update the calendar item identifies the calendar item as qualifying for the live updating.

### EXAMPLE 6

The computing apparatus of Examples 1-5 wherein the update request for the update to the calendar item comprises an open request to open the calendar item in a user interface to the calendar that includes a view of the calendar item.

### EXAMPLE 7

The computing apparatus of Examples 1-6 wherein the live event comprises a sporting event and wherein the status information comprises a live score obtained while the sporting event is ongoing.

### EXAMPLE 8

The computing apparatus of Examples 1-7 wherein the update request for the update to the calendar item comprises a navigation request to navigate to a view of the calendar in the user interface that includes the calendar item, wherein the view comprises one of a monthly view, a weekly view, and a daily view.

### EXAMPLE 9

A method of operating a calendar service comprising: receiving an update request originating from a calendar client for an update to a calendar item in a calendar associated with a user that is related to a live event; communicating a search request to a search service external to the calendar service to search for status information pertaining to the live event; and replying to the update request from the calendar client with the update comprising the status information obtained from the search service.

### EXAMPLE 10

The method of Example 9 wherein communicating the search request to the search service occurs in response to receiving the update request for the update to the calendar item.

### EXAMPLE 11

The method of Examples 9-10 further comprising determining if update requests originating from calendar clients for updates to calendar items qualify for live updating.

### EXAMPLE 12

The method of Examples 9-11 wherein communicating the search request to the search service occurs in response to determining that the calendar item qualifies for the live updating.

### EXAMPLE 13

The method of Examples 9-12 wherein the update request to update the calendar item identifies the calendar item as qualifying for the live updating.

### EXAMPLE 14

The method of Examples 9-13 wherein the update request for the update to the calendar item comprises an open request to open the calendar item in a user interface to the calendar that includes a view of the calendar item.

### EXAMPLE 15

The method of Examples 9-14 wherein the live event comprises a sporting event and wherein the status information comprises a live score obtained while the sporting event is ongoing.

### EXAMPLE 16

The method of Examples 9-15 wherein the update request for the update to the calendar item comprises a navigation request to navigate to a view of the calendar in the user interface that includes the calendar item, wherein the view comprises one of a monthly view, a weekly view, and a daily view.

### EXAMPLE 17

A computing apparatus comprising: one or more computer readable storage media; a processing system operatively coupled with the one or more computer readable storage media; and program instructions stored on the one or more computer readable storage media for operating a calendar client that, when executed by a processing system, direct the processing system to at least: communicate an update request to a calendar service for an update to a calendar item in a calendar associated with a user that is related to a live event; receive a reply to the update request from the calendar service the includes status information obtained by the calendar service from a search service; and surface the status information in a user interface to the calendar.

### EXAMPLE 18

The computing apparatus of Example 17 wherein the update request for the update to the calendar item comprises an open request to open the calendar item in the user interface.

### EXAMPLE 19

The computing apparatus of Example 18 wherein the live event comprises a sporting event and wherein the status information comprises a live score obtained by the calendar service while the sporting event is ongoing.

### EXAMPLE 20

The computing apparatus of Example 19 wherein the update request for the update to the calendar item comprises a navigation request to navigate to a view of the calendar in the user interface that includes the calendar item, wherein the view comprises one of a monthly view, a weekly view, and a daily view.

The functional block diagrams, operational scenarios and sequences, and flow diagrams provided in the Figures are representative of exemplary systems, environments, and methodologies for performing novel aspects of the disclosure. While, for purposes of simplicity of explanation, methods included herein may be in the form of a functional diagram, operational scenario or sequence, or flow diagram, and may be described as a series of acts, it is to be understood and appreciated that the methods are not limited by the order of acts, as some acts may, in accordance therewith, occur in a different order and/or concurrently with other acts from that shown and described herein. For example, those skilled in the art will understand and appreciate that a method could alternatively be represented as a series of interrelated states or events, such as in a state diagram. Moreover, not all acts illustrated in a methodology may be required for a novel implementation.

The descriptions and figures included herein depict specific implementations to teach those skilled in the art how to make and use the best option. For the purpose of teaching inventive principles, some conventional aspects have been simplified or omitted. Those skilled in the art will appreciate variations from these implementations that fall within the scope of the invention. Those skilled in the art will also appreciate that the features described above can be combined in various ways to form multiple implementations. As a result, the invention is not limited to the specific implementations described above, but only by the claims and their equivalents.

1. A computing apparatus comprising:
one or more computer readable storage media;
a processing system operatively coupled with the one or more computer readable storage media; and
program instructions stored on the one or more computer readable storage media for operating a calendar service that, when executed by a processing system, direct the processing system to at least:
receive an update request originating from a calendar client for an update to a calendar item in a calendar associated with a user that is related to a live event;
communicate a search request to a search service external to the calendar service to search for status information pertaining to the live event; and
reply to the update request from the calendar client with the update comprising the status information obtained from the search service.

2. The computing apparatus of claim 1 wherein the program instructions direct the processing system to communicate the search request to the search service in response to the update request for the update to the calendar item.

3. The computing apparatus of claim 2 wherein the program instructions direct the processing system to determine if update requests originating from calendar clients for updates to calendar items qualify for live updating.

4. The computing apparatus of claim 3 wherein the program instructions direct the processing system to communicate the search request to the search service in response to determining that the calendar item qualifies for the live updating.

5. The computing apparatus of claim 4 wherein the update request to update the calendar item identifies the calendar item as qualifying for the live updating.

6. The computing apparatus of claim 2 wherein the update request for the update to the calendar item comprises an open request to open the calendar item in a user interface to the calendar that includes a view of the calendar item.

7. The computing apparatus of claim 6 wherein the live event comprises a sporting event and wherein the status information comprises a live score obtained while the sporting event is ongoing.

8. The computing apparatus of claim 2 wherein the update request for the update to the calendar item comprises a navigation request to navigate to a view of the calendar in a user interface that includes the calendar item, wherein the view comprises one of a monthly view, a weekly view, and a daily view.

9. A method of operating a calendar service comprising:
receiving an update request originating from a calendar client for an update to a calendar item in a calendar associated with a user that is related to a live event;
communicating a search request to a search service external to the calendar service to search for status information pertaining to the live event; and
replying to the update request from the calendar client with the update comprising the status information obtained from the search service.

10. The method of claim 9 wherein communicating the search request to the search service occurs in response to receiving the update request for the update to the calendar item.

11. The method of claim 10 further comprising determining if update requests originating from calendar clients for updates to calendar items qualify for live updating.

12. The method of claim 11 wherein communicating the search request to the search service occurs in response to determining that the calendar item qualifies for the live updating.

13. The method of claim 12 wherein the update request to update the calendar item identifies the calendar item as qualifying for the live updating.

14. The method of claim 10 wherein the update request for the update to the calendar item comprises an open request to open the calendar item in a user interface to the calendar that includes a view of the calendar item.

15. The method of claim 14 wherein the live event comprises a sporting event and wherein the status information comprises a live score obtained while the sporting event is ongoing.

16. The method of claim 10 wherein the update request for the update to the calendar item comprises a navigation request to navigate to a view of the calendar in a user interface that includes the calendar item, wherein the view comprises one of a monthly view, a weekly view, and a daily view.

17. A computing apparatus comprising:
one or more computer readable storage media;
a processing system operatively coupled with the one or more computer readable storage media; and
program instructions stored on the one or more computer readable storage media for operating a calendar client that, when executed by a processing system, direct the processing system to at least:
communicate an update request to a calendar service for an update to a calendar item in a calendar associated with a user that is related to a live event;
receive a reply to the update request from the calendar service the includes status information obtained by the calendar service from a search service; and
surface the status information in a user interface to the calendar.

18. The computing apparatus of claim 17 wherein the update request for the update to the calendar item comprises an open request to open the calendar item in the user interface.

19. The computing apparatus of claim 18 wherein the live event comprises a sporting event and wherein the status information comprises a live score obtained by the calendar service while the sporting event is ongoing.

20. The computing apparatus of claim 17 wherein the update request for the update to the calendar item comprises a navigation request to navigate to a view of the calendar in the user interface that includes the calendar item, wherein the view comprises one of a monthly view, a weekly view, and a daily view.
